(19) United States
(12) Patent Application Publication
(10) Pub. No.: US 2021/0390806 A1
(43) Pub. Date: Dec. 16, 2021

(54) Facial Recognition Security Assembly

(71) Applicant: Michael Duke, Plainfield, IN (US)

(72) Inventor: Michael Duke, Plainfield, IN (US)

(21) Appl. No.: 16/901,468

(22) Filed: Jun. 15, 2020

(51) Int. Cl. G07C 9/00; G06K 9/00; H04N 5/247

(52) U.S. Cl. CPC G07C 9/00563; H04N 5/247; G06K 9/00281; G06K 9/00771

(57) ABSTRACT

A facial recognition security assembly includes a first video camera and a second video camera that are positioned within a business to capture footage of people entering the business. A door locking unit is coupled to a door in the entrance of the business to selectively lock the door. A cash register locking unit is coupled to a cash register in the business to lock the cash register. A facial recognition unit is provided to analyze the footage from the first video camera and the second video camera. The door locking unit locks the door when the facial recognition unit determines that a person approaching the entrance of the business is attempting to conceal their face. Additionally, the cash register locking unit locks the cash register when the facial recognition unit determines that a person approaching the cash register is attempting to conceal their face after entering the business.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

(1) Field of the Invention

The disclosure relates to security devices and more particularly pertains to a new security device for inhibiting a person from entering a business if they attempt to conceal their face.

(2) Description of Related Art Including Information Disclosed Under 37 CFR 1.97 and 1.98.

The prior art relates to security devices including a variety of devices that include video surveillance and a metal detector that are each positioned adjacent to an entrance of a building. In several instances a locking mechanism is included to lock the entrance of the building when a metal object is detected on a person attempting to enter the building. The prior art also discloses an access control gate that has a plurality of lanes, each being selectively restricted by a gate, for controlling access into an area serviced by the lanes. The prior art discloses a wireless building locking device for locking or unlocking a building with a remote control. In no instance is facial recognition capabilities disclosed in combination with locking mechanisms.

### BRIEF SUMMARY OF THE INVENTION

An embodiment of the disclosure meets the needs presented above by generally comprising a first video camera and a second video camera that are positioned within a business to capture footage of people entering the business. A door locking unit is coupled to a door in the entrance of the business to selectively lock the door. A cash register locking unit is coupled to a cash register in the business to lock the cash register. A facial recognition unit is provided to analyze the footage from the first video camera and the second video camera. The door locking unit locks the door when the facial recognition unit determines that a person approaching the entrance of the business is attempting to conceal their face. Additionally, the cash register locking unit locks the cash register when the facial recognition unit determines that a person approaching the cash register is attempting to conceal their face after entering the business.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a facial recognition security assembly according to an embodiment of the disclosure.

FIG. 2 is a schematic view of an embodiment of the disclosure.

FIG. 3 is a perspective view of a cash register in a business of an embodiment of the disclosure.

### DETAILED DESCRIPTION OF THE INVENTION

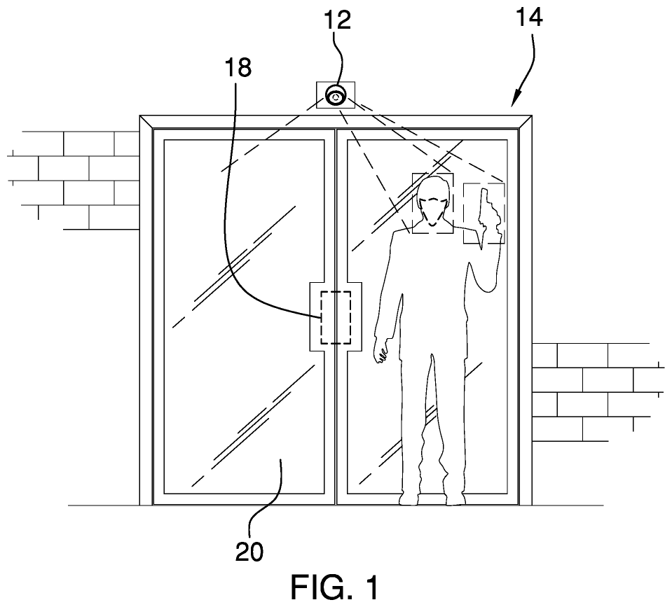

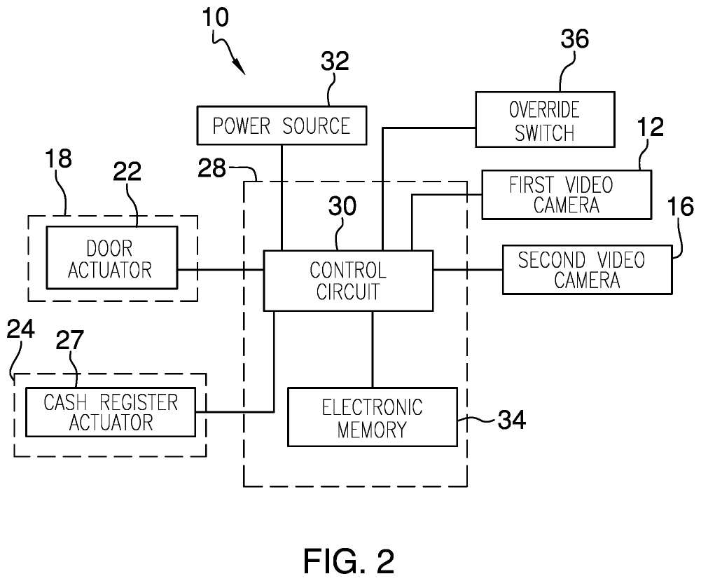

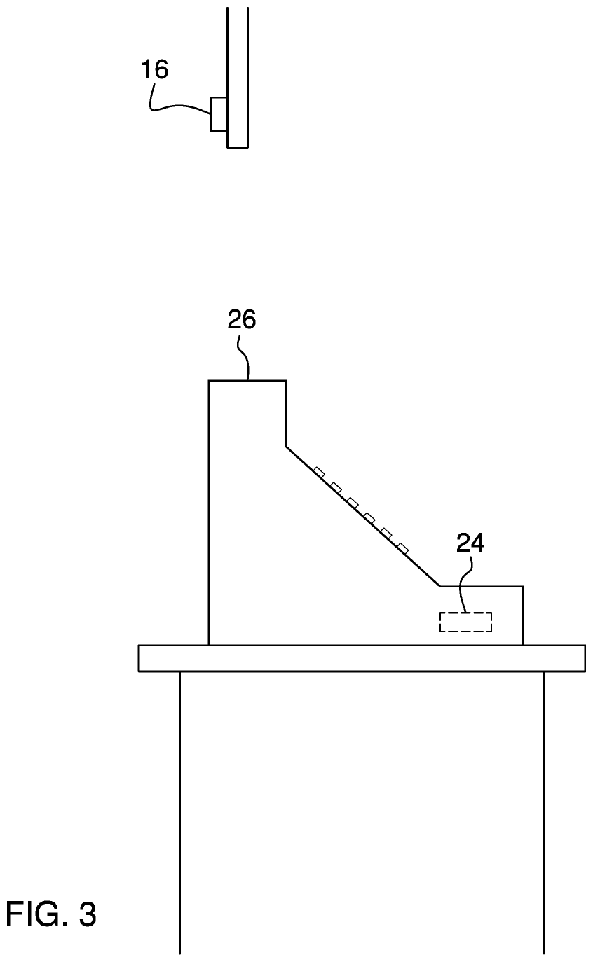

With reference now to the drawings, and in particular to FIGS. 1 through 3 thereof, a new security device embodying the principles and concepts of an embodiment of the disclosure and generally designated by the reference numeral 10 will be described.

As best illustrated in FIGS. 1 through 3, the facial recognition security assembly 10 generally comprises a first video camera 12 that is positioned at an entrance 14 of a business to capture footage of people approaching the entrance 14 to the business. The business may be any retail business that has a checkout counter and a cash register. The first video camera 12 may be a digital video camera of any conventional design. A second video camera 16 is positioned within the business to capture footage of people approaching the cash register in the business. The second video camera 16 may be a digital video camera of any conventional design.

A door locking unit 18 is coupled to a door 20 in the entrance 14 of the business. The door locking unit 18 is actuatable into a locking condition for locking the door 20 to inhibit people from entering the entrance 14. The door locking unit 18 is actuatable into an unlocked condition for unlocking the door 20 to facilitate people to enter the entrance 14. The door locking unit 18 comprises a door actuator 22 that is coupled to the door 20. Moreover, the door actuator 22 may engage a door frame in which the door 20 is positioned when the door actuator 22 is turned on thereby inhibiting the door 20 from being opened. The door actuator 22 disengages the door frame when the door actuator 22 is turned off thereby facilitating the door 20 to be opened. The door actuator 22 may be an electronic actuator that is common to automatic locking systems of doors or other similar device. As is most clearly shown in FIG. 1, a pair of the doors 20 may be provided and the door actuator 22 may engage each of the doors 20 when the door actuator 22 is turned on for locking the pair of doors 20.

A cash register locking unit 24 is coupled to a cash register 26 in the business. The cash register locking unit 24 is actuatable into a locking condition for locking the cash register 26 to inhibit a thief from accessing the cash register 26. The cash register locking unit 24 is actuatable into an unlocked condition for unlocking the cash register 26. The cash register locking unit 24 comprises a cash register actuator 27 that is coupled to the cash register 26. The cash register actuator 27 engages a cash drawer on the cash register 26 when the cash register actuator 27 is turned on thereby inhibiting the cash drawer from being opened. The cash register actuator 27 disengages the cash drawer when the cash register actuator 27 is turned off thereby facilitating the cash drawer to be opened. The cash register actuator 27 may be an electronic actuator similar to that of the door actuator 22.

A facial recognition unit 28 is provided and the facial recognition unit 28 is in communication with the first video camera 12. In this way the facial recognition unit 28 can analyze the footage of the people approaching the entrance 14 of the business. The facial recognition unit 28 is in communication with the second video camera 16 to analyze footage of the people approaching the cash register 26. The facial recognition unit 28 broadcasts a lock signal to the door locking unit 18 when the facial recognition unit 28 determines that a person approaching the entrance 14 of the business is attempting to conceal their face. Additionally, the facial recognition unit 28 broadcasts a lock signal to the cash register locking unit 24 when the facial recognition unit 28 determines that a person approaching the cash register 26 is attempting to conceal their face after entering the business.

The facial recognition unit 28 comprises a control circuit 30 that is positioned in the facial recognition unit 28. The control circuit 30 is in electrical communication with the door actuator 22, the cash register actuator 27, the first video camera 12 and the second video camera 16. The control circuit 30 receives a door lock input and the control circuit 30 receives a cash register lock input. The control circuit 30 is in electrical communication with a power source 32 comprising an electrical system of the business.

The facial recognition unit 28 includes an electronic memory 34 that is positioned in the facial recognition unit 28. The electronic memory 34 stores operational software comprising a facial recognition program. Moreover, the facial recognition program analyzes the footage from the first video camera 12 and the second video camera 16. The facial recognition program includes functions that can identify if the person is wearing a mask that has been required to be worn, such as a particulate mask worn for protection against COVID or other pathogen. In this way the facial recognition program can differentiate between a person that is wearing a full face mask, for example, and a person that is wearing a mask that only covers the person's mouth and nose. Additionally, the electronic memory 34 stores operational software for identifying a potential weapon being carried by the person. The electronic memory 34 stores the video footage captured by the first video camera 12 and the second video camera 16 for subsequent analysis by law enforcement for the purposes of identifying and prosecuting the person that is attempting to conceal their face for the purposes of committing a crime.

The control circuit 30 receives the door lock input when the facial recognition program determines the person approaching the entrance 14 of the business is attempting to conceal their face or is potentially carrying a weapon. Each of the door actuator 22 and the cash register actuator 27 is turned on when the control circuit 30 receives the door lock input. In this way the person attempting to conceal their face is inhibited from entering the business. The control circuit 30 receives the cash register lock input when the facial recognition software determines the person approaching the cash register 26 is attempting to conceal their face. The cash register actuator 27 is turned on when the control circuit 30 receives the cash register lock input. In this way the person attempting to conceal their face as they approach the cash register 26 is inhibited from committing theft of cash in the cash register 26. Additionally, the control circuit 30 receives the door lock input when the facial recognition software determines that the person approaching the entrance 14 of the business is not wearing a required mask, such as the particulate mask for protection against pathogens. In this way the occupants of the building can be protected from potential exposure to pathogens by the person that is not wearing the required mask.

An override switch 36 is positioned at a discrete location within the business such that the override switch 36 is accessible to a manager of the business. The override switch 36 is in communication with each of the door locking unit 18 and the cash register locking unit 24. Additionally, each of the door locking unit 18 and the cash register locking unit 24 is turned off when the override switch 36 is engaged. The override switch 36 is electrically coupled to the control circuit 30, and each of the door actuator 22 and the cash register actuator 27 is turned off when the override switch 36 is engaged.

In use, the door 20 and the cash register 26 are locked when a person approaching the entry to the business attempts to conceal their face. In this way the person attempting to conceal their face is inhibited from entering the business and potentially committing a robbery. Additionally, the cash register 26 is locked with the person that has entered the business attempts to conceal their face after they have entered the business. In this way the person who has entered the business without initially concealing their face is inhibited from committing a robbery. Each of the door 20 and the cash register 26 are unlocked when the manager engages the override switch 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A facial recognition security assembly for automatically locking an entrance to a business when an individual attempts to conceal their face while entering, said assembly comprising:
a first video camera being positioned at an entrance of a business wherein said first video camera is configured to capture footage of people approaching the entrance to the business;
a second video camera being positioned within the business wherein said second video camera is configured to capture footage of people approaching a cash register in the business;
a door locking unit being coupled to a door in the entrance of the business, said door locking unit being actuatable into a locking condition for locking the door wherein said door locking unit is configured to inhibit people from entering the entrance, said door locking unit being actuatable into an unlocked condition for unlocking the door wherein said door locking unit is configured to facilitate people to enter the entrance;
a cash register locking unit being coupled to a cash register in the business, said cash register locking unit being actuatable into a locking condition for locking the cash register wherein said cash register locking unit is configured to inhibit a thief from accessing the cash register, said cash register locking unit being actuatable into an unlocked condition for unlocking the cash register; and
a facial recognition unit being in communication with said first video camera wherein said facial recognition unit is configured to analyze the footage of the people approaching the entrance of the business, said facial recognition unit being in communication with said second video camera wherein said facial recognition unit is configured to analyze footage of the people approaching the cash register, said facial recognition unit broadcasting a lock signal to said door locking unit when said facial recognition unit determines that a person approaching the entrance of the business is attempting to conceal their face, said facial recognition unit broadcasting a lock signal to said cash register locking unit when said facial recognition unit determines that a person approaching the cash register is attempting to conceal their face after entering the business.

2. The assembly according to claim 1, wherein said door locking unit comprises a door actuator being coupled to the door, said door actuator engaging a door frame in which the door is positioned when said door actuator is turned on thereby inhibiting the door from being opened, said door actuator disengaging the door frame when said door actuator is turned off thereby facilitating the door to be opened.

3. The assembly according to claim 1, wherein said cash register locking unit comprises a cash register actuator being coupled to the cash register, said cash register actuator engaging a cash drawer on the cash register when said cash register actuator is turned on thereby inhibiting the cash drawer from being opened, said cash register actuator disengaging the cash drawer when said cash register actuator is turned off thereby facilitating the cash drawer to be opened.

4. The assembly according to claim 1, wherein:
said door locking unit includes a door actuator;
said cash register locking unit includes a cash register actuator; and
said facial recognition unit comprises a control circuit being positioned in said facial recognition unit, said control circuit being in electrical communication with said door actuator, said control circuit being in electrical communication with said cash register actuator, said control circuit being in electrical communication with said first video camera, said control circuit being in electrical communication with said second video camera, said control circuit receiving a door lock input, said control circuit receiving a cash register lock input, said control circuit being in electrical communication with a power source comprising an electrical system of the business.

5. The assembly according to claim 4, wherein said facial recognition unit includes an electronic memory being positioned in said facial recognition unit, said electronic memory storing operational software comprising a facial recognition program thereby facilitating said facial recognition program to analyze the footage from said first video camera and said second video camera.

6. The assembly according to claim 5, wherein said control circuit receives said door lock input when said facial recognition program determines the person approaching the entrance of the business is attempting to conceal their face, each of said door actuator and said cash register actuator being turned on when said control circuit receives said door lock input.

7. The assembly according to claim 5, wherein said control circuit receives said cash register lock input when said facial recognition software determines the person approaching the cash register is attempting to conceal their face, said cash register actuator being turned on when said control circuit receives said cash register locking input.

8. The assembly according to claim 4, further comprising an override switch being positioned within at a discrete location within the business wherein said override switch is configured to be accessible to a manager of the business, said override switch being in communication with each of said door locking unit and said cash register locking unit, each of said door locking unit and said cash register locking unit being turned off when said override switch is engaged, said override switch being electrically coupled to said control circuit.

9. A facial recognition security assembly for automatically locking an entrance to a business when an individual attempts to conceal their face while entering, said assembly comprising:
a first video camera being positioned at an entrance of a business wherein said first video camera is configured to capture footage of people approaching the entrance to the business;
a second video camera being positioned within the business wherein said second video camera is configured to capture footage of people approaching a cash register in the business;
a door locking unit being coupled to a door in the entrance of the business, said door locking unit being actuatable into a locking condition for locking the door wherein said door locking unit is configured to inhibit people from entering the entrance, said door locking unit being actuatable into an unlocked condition for unlocking the door wherein said door locking unit is configured to facilitate people to enter the entrance, said door locking unit comprising a door actuator being coupled to the door, said door actuator engaging a door frame in which the door is positioned when said door actuator is turned on thereby inhibiting the door from being opened, said door actuator disengaging the door frame when said door actuator is turned off thereby facilitating the door to be opened;
a cash register locking unit being coupled to a cash register in the business, said cash register locking unit being actuatable into a locking condition for locking the cash register wherein said cash register locking unit is configured to inhibit a thief from accessing the cash register, said cash register locking unit being actuatable into an unlocked condition for unlocking the cash register, said cash register locking unit comprising a cash register actuator being coupled to the cash register, said cash register actuator engaging a cash drawer on the cash register when said cash register actuator is turned on thereby inhibiting the cash drawer from being opened, said cash register actuator disengaging the cash drawer when said cash register actuator is turned off thereby facilitating the cash drawer to be opened;
a facial recognition unit being in communication with said first video camera wherein said facial recognition unit is configured to analyze the footage of the people approaching the entrance of the business, said facial recognition unit being in communication with said second video camera wherein said facial recognition unit is configured to analyze footage of the people approaching the cash register, said facial recognition unit broadcasting a lock signal to said door locking unit when said facial recognition unit determines that a person approaching the entrance of the business is attempting to conceal their face, said facial recognition unit broadcasting a lock signal to said cash register locking unit when said facial recognition unit determines that a person approaching the cash register is attempting to conceal their face after entering the business, said facial recognition unit comprising:
a control circuit being positioned in said facial recognition unit, said control circuit being in electrical communication with said door actuator, said control circuit being in electrical communication with said cash register actuator, said control circuit being in electrical communication with said first video camera, said control circuit being in electrical communication with said second video camera, said control circuit receiving a door lock input, said control circuit receiving a cash register lock input, said control circuit being in electrical communication with a power source comprising an electrical system of the business; and
an electronic memory being positioned in said facial recognition unit, said electronic memory storing operational software comprising a facial recognition program thereby facilitating said facial recognition program to analyze the footage from said first video camera and said second video camera, said control circuit receiving said door lock input when said facial recognition program determines the person approaching the entrance of the business is attempting to conceal their face, each of said door actuator and said cash register actuator being turned on when said control circuit receives said door lock input, said control circuit receiving said cash register lock input when said facial recognition software determines the person approaching the cash register is attempting to conceal their face, said cash register actuator being turned on when said control circuit receives said cash register locking input; and
an override switch being positioned within at a discrete location within the business wherein said override switch is configured to be accessible to a manager of the business, said override switch being in communication with each of said door locking unit and said cash register locking unit, each of said door locking unit and said cash register locking unit being turned off when said override switch is engaged, said override switch being electrically coupled to said control circuit, each of said door actuator and said cash register actuator being turned off when said override switch is engaged.
